(19) United States
(12) Patent Application Publication
(10) Pub. No.: US 2009/0302249 A1
(43) Pub. Date: Dec. 10, 2009

(54) Pneumatic energy saving control

(76) Inventor: George Allen Fincher, Discovery Bay, CA (US)

Correspondence Address: George Fincher, 4114 Beacon Place, Discovery Bay, CA, 94514, US

(21) Appl. No.: 12/264,844

(22) Filed: Nov. 4, 2008

Related U.S. Application Data
(60) Provisional application No. 60/986,664, filed on Nov. 9, 2007.

(51) Int. Cl. F16K 31/02

(52) U.S. Cl. 251/129.04

(57) ABSTRACT

The objective of the invention is to bypass the existing pneumatic thermostats/controllers providing on off auto operation for VAV boxes, reheat coils, classroom unit ventilators, fan coil units, fin tube radiators, damper actuator's, water control valves and the like, with a remotely controlled three way valves and wireless controlled and self-contained power.

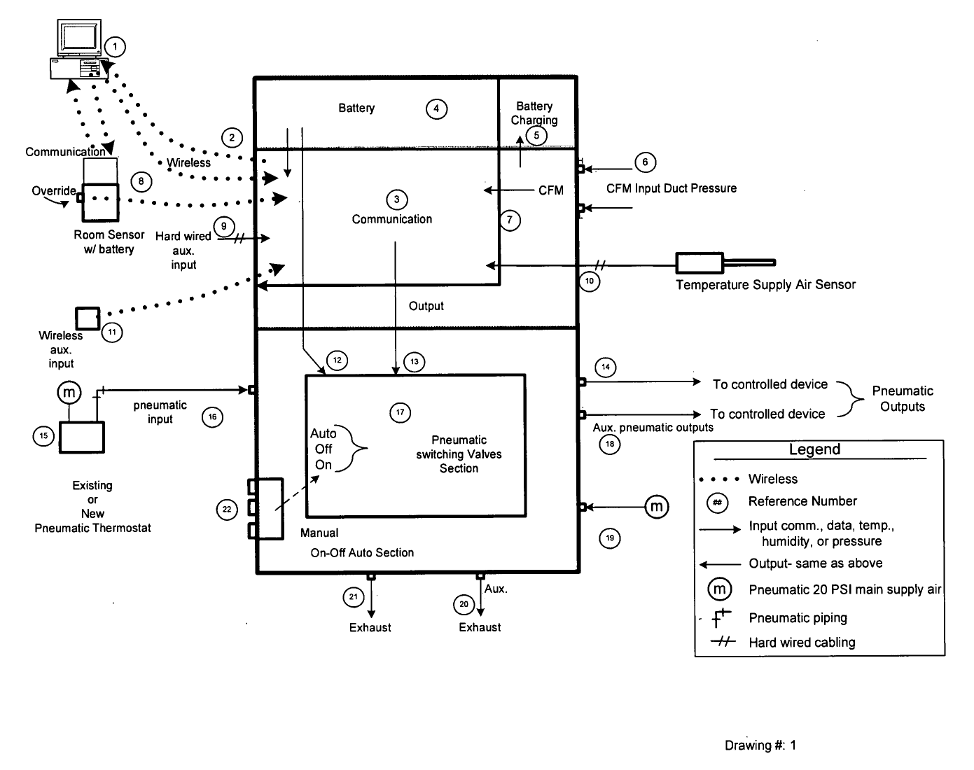

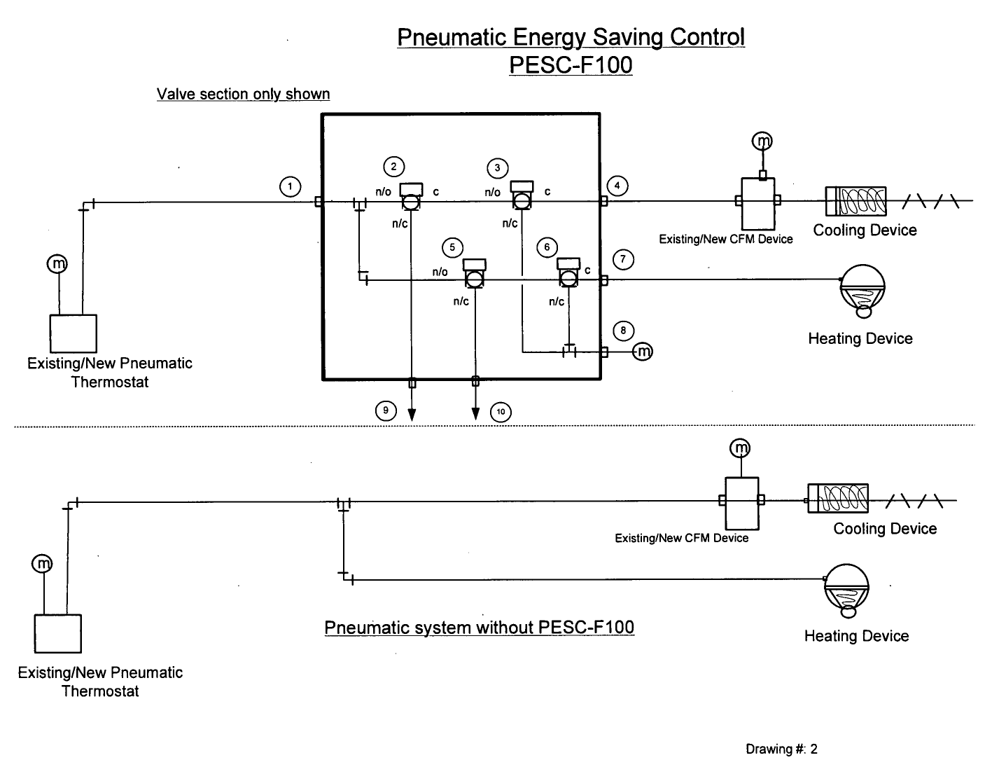

The present invention relates to a pneumatic energy savings control that provides a pneumatic on off auto sequence to existing or new pneumatic control system. The invention is comprised three-way pneumatic switching valves; power supply; wireless room sensor, supply air sensor; and or any pressure temperature or humidity sensing.

The invention is directed to bypass the existing or new pneumatic thermostats/controllers providing on off auto operation for VAV boxes, reheat coils, unit ventilators, fan coil units, fin tube radiators, damper actuator's, water control valves and the like, with a remotely controlled three way valves and wireless controlled and self-contained power. Pneumatic thermostats are simple and proven reliable. Pneumatic damper actuators and valve actuators consists of a diaphragm and a spring complementing the pneumatic thermostat with economical and reliable control. A typical installation for this invention would be to install the device in the ceiling next to the VAV terminal box. Room temperature, supply air temperature, motion and/or light detector input and supply air volume (CFM) would be in information inputs to the invention. A remote computer would be capable of monitoring input information and sending output signals to place the invention into one of three modes: on/off/auto.

The invention provides for the following sequences by overriding/bypassing with on off auto pneumatic switching valves:
Individual schedules for each pneumatic thermostatically controlled zone.
(Unoccupied/override off, override on or auto.)
Pushbutton or computer generated timed override for after our occupancy.
Temperature setpoint limitations preventing the pneumatic thermostat from extreme setpoint conditions. Motion and/or light detector input (occupancy) to limit temperature setpoints in unoccupied periods. Providing for override data logging for tenant billing opportunities.
Provide room temperature, motion and/or light detector input, supply air temperature and supply air volume monitoring.
Provide alarms base on various input conditions.
The fail safe sequence would place the invention into auto mode allowing the pneumatic thermostat to control.
Provide battery charging and battery condition information.

Typically the room temperature sensor will be located on a desk closest to the pneumatic thermostat. The sensor will be combined with a communication node and be the hub of communications between the remote computer and the invention located in the ceiling. The desktop sensor/communication node would be able to utilize all of the communications capabilities, existing networks and power located next to a typical desk.

### SUMMARY OF THE INVENTION

It is the object; feature an advantage of the present invention to provide on off auto pneumatic switching of new or existing pneumatic thermostats or controls.

It is the object; feature an advantage of the present invention to provide the ability to override existing/new pneumatic thermostats or controls without requiring wiring for an external power source.

It is the object feature an advantage of the present invention to provide a convenient ceiling mounted control bypass with an internal power source.

It is the object; feature an advantage of the present invention to provide bypass switching on and off auto of existing or new controls using wireless communications and remote control.

It is the object feature an advantage of the present invention to provide a means of switching on and off auto which uses new or existing pneumatic air piping to control pneumatically actuated devices.

It is the object, feature an advantage of the present invention to provide on off auto control of new or existing pneumatic thermostats or controllers and have input capabilities to monitor room temperatures, supply air temperatures, supply air cubic feet per minute, heating temperatures, cooling temperatures, humidity, pressure, lighting by means of hardwiring or wireless communications of any type.

It is the object, feature an advantage of the present invention to provide on off auto control of new or existing pneumatic thermostats or controllers comprising of an air inlet from the pneumatic thermostat/controller, a main air supply inlet, two or more exhaust air outlets and two or more air outlets to the controlled devices.

It is the object, feature an advantage of the present invention to provide on off auto control of new or existing pneumatic thermostats or controllers self-contained power supply capable of being recharged utilizing ductwork static pressure.

The present invention provides a method of bypassing the existing or new pneumatic controls that are controlling pneumatic devices. Capable of communicating with wireless modules and receiving wireless commands.

Capable of communicating with hardwired modules and receiving hardwired commands.

What is claimed is:

1) An object, feature and advantage that provides a pneumatic bypass of the existing pneumatic thermostat/control using wireless communication to provide on off auto sequence to any pneumatically controlled device.
A pneumatic bypass comprising of Pneumatic switching valves that provide on off auto sequence to the controlled devices. A self-contained power source hardwired or wireless means of receiving and transmitting remote signals. Directly connected by high and low pneumatic tubes to the air duct.
The controller of claim wherein includes motorized, solenoid or pneumatically actuated bypass valves two way or three way in combination to provide on off auto sequence to controlled devices.
The controller of claim wherein includes a manual on off auto selection switch. That overrides the remote wireless signal.
The controller of claim wherein includes monitoring of pneumatic input pressure from the existing or new pneumatic thermostat/control, pneumatics supply air pressure and pneumatic pressure output pressure to controlled devices.
The controller of claim wherein includes battery charging from supply air duct static pressure.
